(19) United States
(12) Patent Application Publication
(10) Pub. No.: US 2024/0244360 A1
(43) Pub. Date: Jul. 18, 2024

(54) EARPLUG

(71) Applicant: Shiningtek Electronics Corp., Hsinchu City (TW)

(72) Inventor: Being-Ruey Su, Hsinchu City (TW)

(73) Assignee: Shiningtek Electronics Corp., Hsinchu City (TW)

(21) Appl. No.: 18/123,322

(22) Filed: Mar. 19, 2023

Related U.S. Application Data
(60) Provisional application No. 63/439,851, filed on Jan. 18, 2023.

(51) Int. Cl. H04R 1/10

(52) U.S. Cl. CPC H04R 1/1016

(57) ABSTRACT

An earplug includes a hollow tube and a cover. The hollow tube has a top portion, a deformable curved portion and a first intermediate portion. The deformable curved portion is located between the top portion and the first intermediate portion. The deformable curved portion has an outer convex structure and an inner concave structure corresponding to the outer convex structure. The cover is connected to the top portion and surrounds the hollow tube.

### CROSS REFERENCE TO RELATED APPLICATIONS

This application claims the benefit of U.S. Provisional Application No. 63/439,851, filed on Jan. 18, 2023. The content of the application is incorporated herein by reference.

### BACKGROUND OF THE INVENTION

### 1. Field of the Invention

The invention relates to an earplug and, more particularly, to an earplug capable of fitting an ear canal more ergonomically and snugly.

### 2. Description of the Prior Art

An earphone is often used in personal computers, notebook computers, smart phones, tablet computers and music players to provide a high-quality listening experience. In general, the earphone is equipped with an earplug to be plugged into an ear canal. However, since the ear canals of different users are different from each other in size, the earplug cannot always fit all ear canals well. Thus, there will be gaps between the earplug and the ear canal, such that the listening experience may be affected, the user may feel uncomfortable, and the earphone with the earplug may come off the ear canal easily.

### SUMMARY OF THE INVENTION

The invention provides an earplug capable of fitting an ear canal more ergonomically and snugly, so as to solve the aforesaid problems.

According to an embodiment of the invention, an earplug comprises a hollow tube and a cover. The hollow tube has a top portion, a deformable curved portion and a first intermediate portion. The deformable curved portion is located between the top portion and the first intermediate portion. The deformable curved portion has an outer convex structure and an inner concave structure corresponding to the outer convex structure. The cover is connected to the top portion and surrounds the hollow tube.

Preferably, the deformable curved portion is able to be bent between 0˜50 degrees.

Preferably, a height of the deformable curved portion is between 1˜7 mm.

Preferably, a maximum inner diameter of the inner concave structure is larger than minimum inner diameters of the top portion and the first intermediate portion by 0.1˜4.8 mm.

Preferably, a maximum outer diameter of the outer convex structure is larger than a minimum outer diameter of the first intermediate portion by 0.1˜4.8 mm.

Preferably, a height of the first intermediate portion is between 0.1˜5 mm.

Preferably, the hollow tube further has a second intermediate portion located between the top portion and the deformable curved portion, the deformable curved portion is located between the second intermediate portion and the first intermediate portion, and the first intermediate portion and the second intermediate portion have uniform diameters.

Preferably, a height of the first intermediate portion is between 0.1˜5 mm and a height of the second intermediate portion is between 0.1˜5 mm.

Preferably, minimum inner diameters of the top portion and the second intermediate portion are larger than an inner diameter of the first intermediate portion.

Preferably, the hollow tube further has a bottom portion, the first intermediate portion is located between the deformable curved portion and the bottom portion, and an inner diameter of the bottom portion is smaller than an inner diameter of the first intermediate portion, such that the bottom portion has an engaging structure adjacent to the first intermediate portion.

Preferably, the top portion defines a sound outlet and the bottom portion defines a sound inlet.

As mentioned in the above, the hollow tube of the earplug has the deformable curved portion, wherein the deformable curved portion has the outer convex structure and the inner concave structure corresponding to the outer convex structure. Accordingly, when an earphone is equipped with the earplug of the invention and then plugged into an ear canal, the deformable curved portion will be compressed by the ear canal to deform, such that the top portion of the earplug can be adjusted to fit the ear canal more ergonomically and snugly, and low frequency sounds can be listened by the user more clearly. Thereof, the earplug of the invention can enhance the listening experience, make the user feel comfortable, and prevent the earphone with the earplug from coming off the ear canal easily.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a perspective view illustrating an earplug according to an embodiment of the invention.

FIG. 2 is a sectional view illustrating the earplug shown in FIG. 1.

FIG. 3 is a sectional view illustrating an earplug according to another embodiment of the invention.

### DETAILED DESCRIPTION

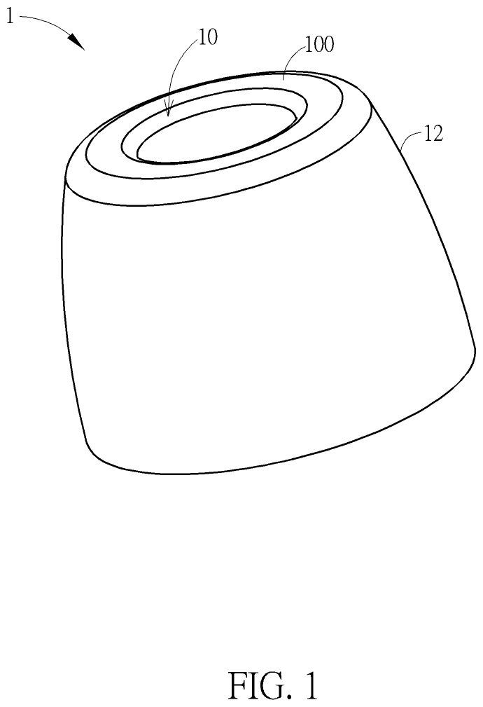

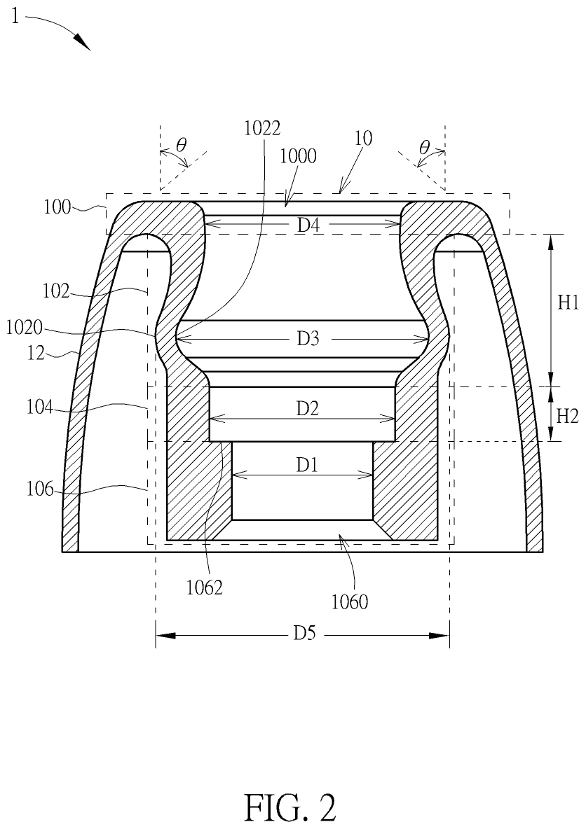

Referring to FIGS. 1 and 2, FIG. 1 is a perspective view illustrating an earplug 1 according to an embodiment of the invention and FIG. 2 is a sectional view illustrating the earplug 1 shown in FIG. 1.

As shown in FIGS. 1 and 2, the earplug 1 comprises a hollow tube 10 and a cover 12. In this embodiment, the hollow tube 10 may have a top portion 100, a deformable curved portion 102, a first intermediate portion 104 and a bottom portion 106, wherein the deformable curved portion 102 is located between the top portion 100 and the first intermediate portion 104, and the first intermediate portion 104 is located between the deformable curved portion 102 and the bottom portion 106. Furthermore, the cover 12 is connected to the top portion 100 and surrounds the hollow tube 10. The earplug 1 may be made of rubber or other flexible materials according to practical applications, such that the earplug 1 will be compressed by an ear canal to deform as the earplug 1 is being plugged into the ear canal.

In this embodiment, the top portion 100 may define a sound outlet 1000 and the bottom portion 106 may define a sound inlet 1060. Still further, an inner diameter D1 of the bottom portion 106 may be smaller than an inner diameter D2 of the first intermediate portion 104, such that the bottom portion 106 may have an engaging structure 1062 adjacent to the first intermediate portion 104. Thus, an earphone (not shown) may be inserted into the earplug 1 through the sound inlet 1060 and engaged with the engaging structure 1062, so as to assemble the earplug 1 on the earphone. When the earphone with the earplug 1 is plugged into an ear canal, the sound outputted by the earphone is able to be delivered to the ear canal through the sound outlet 1000.

As shown in FIG. 2, the deformable curved portion 102 has an outer convex structure 1020 and an inner concave structure 1022 corresponding to the outer convex structure 1020. For further explanation, the outer convex structure 1020 is located at the outside of the hollow tube 10 and faces the cover 12, and the inner concave structure 1022 is located at the inside of the hollow tube 10, wherein the outer convex structure 1020 and the inner concave structure 1022 are ring-shaped.

In this embodiment, the deformable curved portion 102 is able to be bent by an angle θ toward the center of the hollow tube 10, wherein the angle θ may be between 0˜50 degrees. In addition, a height H1 of the deformable curved portion 102 may be between 1˜7 mm. Accordingly, when an earphone is equipped with the earplug 1 and then plugged into an ear canal, the deformable curved portion 102 will be compressed by the ear canal to deform, such that the top portion 100 of the earplug 1 can be adjusted to fit the ear canal more ergonomically and snugly, and low frequency sounds can be listened by the user more clearly.

In this embodiment, a maximum inner diameter D3 of the inner concave structure 1022 may be larger than minimum inner diameters D4, D2 of the top portion 100 and the first intermediate portion 104 by 0.1˜4.8 mm. Furthermore, a height H2 of the first intermediate portion 104 may be between 0.1˜5 mm. Moreover, a maximum outer diameter D5 of the outer convex structure 1020 may be larger than a minimum outer diameter D5 of the first intermediate portion 104 by 0.1˜4.8 mm. Accordingly, when an earphone is equipped with the earplug 1, there is no obstacle between the earphone and the sound outlet 1000, such that the sound outputted by the earphone will not be blocked or affected. Consequently, the sound can be more authentic for the user wearing the earphone with the earplug 1.

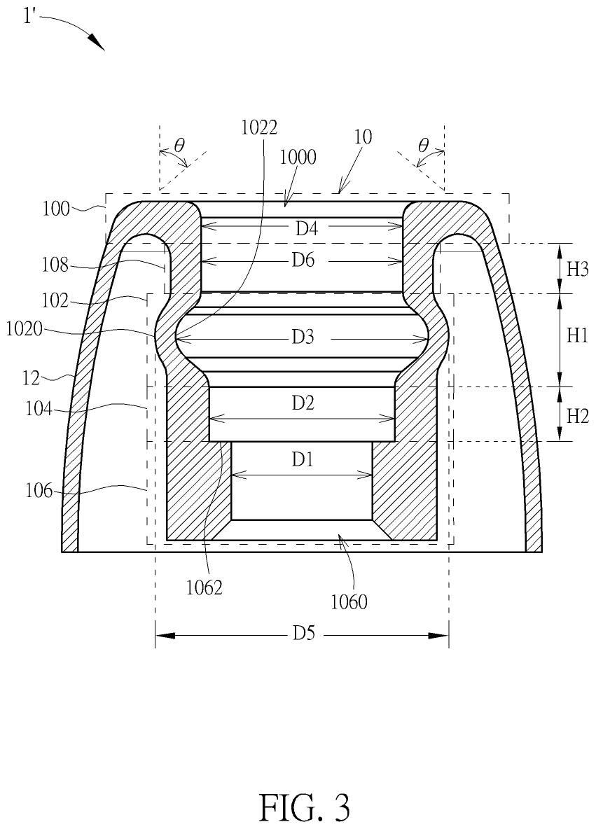

Referring to FIG. 3, FIG. 3 is a sectional view illustrating an earplug 1′ according to another embodiment of the invention.

The main difference between the earplug 1′ and the aforesaid earplug 1 is that the hollow tube 10 of the earplug 1′ further has a second intermediate portion 108 located between the top portion 100 and the deformable curved portion 102, as shown in FIG. 3. In this embodiment, the deformable curved portion 102 is located between the second intermediate portion 108 and the first intermediate portion 104. It should be noted that the same elements in FIG. 3 and FIG. 2 are represented by the same numerals, so the repeated explanation will not be depicted herein again.

In this embodiment, the first intermediate portion 104 and the second intermediate portion 108 adjacent to opposite sides of the deformable curved portion 102 have uniform diameters. Furthermore, a height H2 of the first intermediate portion 104 may be between 0.1˜5 mm and a height H3 of the second intermediate portion 108 may be between 0.1˜5 mm. Moreover, minimum inner diameters D4, D6 of the top portion 100 and the second intermediate portion 108 may be larger than the inner diameter D2 of the first intermediate portion 104. Accordingly, when an earphone is equipped with the earplug 1′, there is no obstacle between the earphone and the sound outlet 1000, such that the sound outputted by the earphone will not be blocked or affected. Consequently, the sound can be more authentic for the user wearing the earphone with the earplug 1′.

As mentioned in the above, the hollow tube of the earplug has the deformable curved portion, wherein the deformable curved portion has the outer convex structure and the inner concave structure corresponding to the outer convex structure. Accordingly, when an earphone is equipped with the earplug of the invention and then plugged into an ear canal, the deformable curved portion will be compressed by the ear canal to deform, such that the top portion of the earplug can be adjusted to fit the ear canal more ergonomically and snugly, and low frequency sounds can be listened by the user more clearly. Furthermore, there is no obstacle between the earphone and the sound outlet, such that the sound outputted by the earphone will not be blocked or affected. Consequently, the sound can be more authentic for the user wearing the earphone with the earplug. Thereof, the earplug of the invention can enhance the listening experience, make the user feel comfortable, and prevent the earphone with the earplug from coming off the ear canal easily.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An earplug comprising:
a hollow tube having a top portion, a deformable curved portion and a first intermediate portion, the deformable curved portion being located between the top portion and the first intermediate portion, the deformable curved portion having an outer convex structure and an inner concave structure corresponding to the outer convex structure; and
a cover connected to the top portion and surrounding the hollow tube.

2. The earplug of claim 1, wherein the deformable curved portion is able to be bent between 0˜50 degrees.

3. The earplug of claim 1, wherein a height of the deformable curved portion is between 1˜7 mm.

4. The earplug of claim 1, wherein a maximum inner diameter of the inner concave structure is larger than minimum inner diameters of the top portion and the first intermediate portion by 0.1˜4.8 mm.

5. The earplug of claim 1, wherein a maximum outer diameter of the outer convex structure is larger than a minimum outer diameter of the first intermediate portion by 0.1˜4.8 mm.

6. The earplug of claim 1, wherein a height of the first intermediate portion is between 0.1˜5 mm.

7. The earplug of claim 1, wherein the hollow tube further has a second intermediate portion located between the top portion and the deformable curved portion, the deformable curved portion is located between the second intermediate portion and the first intermediate portion, and the first intermediate portion and the second intermediate portion have uniform diameters.

8. The earplug of claim 7, wherein a height of the first intermediate portion is between 0.1˜5 mm and a height of the second intermediate portion is between 0.1˜5 mm.

9. The earplug of claim 7, wherein minimum inner diameters of the top portion and the second intermediate portion are larger than an inner diameter of the first intermediate portion.

10. The earplug of claim 1, wherein the hollow tube further has a bottom portion, the first intermediate portion is located between the deformable curved portion and the bottom portion, and an inner diameter of the bottom portion is smaller than an inner diameter of the first intermediate portion, such that the bottom portion has an engaging structure adjacent to the first intermediate portion.

11. The earplug of claim 10, wherein the top portion defines a sound outlet and the bottom portion defines a sound inlet.
